(19) United States
(12) Patent Application Publication
(10) Pub. No.: US 2009/0063311 A1
(43) Pub. Date: Mar. 5, 2009

(54) Adjusted Net Income

(75) Inventors: Thayer S. Allison, JR., Charlotte, NC (US); Sudeshna Banerjee, Waxhaw, NC (US); Timothy J. Bendel, Charlotte, NC (US); Debashis Ghosh, Charlotte, NC (US); David Joa, Pacifica, CA (US); Kurt Newman, Matthews, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 11/848,963

(22) Filed: Aug. 31, 2007

(51) Int. Cl. G06Q 40/00; G06F 17/40

(52) U.S. Cl. 705/30

(57) ABSTRACT

Techniques for enhanced assessment of the business value of an account and/or customer are disclosed. An adjusted net income value outputted by a system may be used by a financial institution, such as a bank, mortgage broker, lender, or credit card company, to better assess the business value and/or profitability of an account. For accounts that are delinquent at the end of an observation period, the adjusted net income value is equal to the net income minus the percentage of the past due balance that is predicted to get charged off. The percentage of the past due balance that is predicted to get charged off relates to the number of days the account has been delinquent.

### FIELD OF THE INVENTION

Aspects of the disclosure generally relate to evaluating business value associated with an account.

### BACKGROUND

Banks have traditionally employed a “risk group” to evaluate risk associated with charge off loss and delinquency (i.e., a leading indicator of charge off loss) on an account. In addition, the risk group may be responsible for complying with regulatory requirements related to the disclosure of how many accounts are delinquent and how delinquent are they (e.g., number of days). When the risk group assesses an account, it may look at the likelihood that the balance on the account may result in a charge off loss or that there is a delay in payment of the balance (e.g., delinquent). Results of the analysis were used to develop criteria to approve or decline an account or customer. The criteria were also used to make decisions about accounts or select customers for marketing campaigns.

In assessing the complete business value of an account, simply predicting only charge off loss amount or delinquency does not accurately assess and optimize the complete business value of an account and/or customer. Moreover, grouping all accounts that have a charge off loss together and grouping together all accounts that do not have a charge off loss does not necessarily result in an accurate assessment of the complete business value of an account and/or customer.

Meanwhile, a bank may also have other groups in its organization responsible for marketing, finance, and other aspects of an account. Each of these groups may assess the business value of an account differently and from different aspects. However, there exists a need for convenient techniques and systems for assessing the complete business value of an account that take the numerous aspects of an account into consideration.

### BRIEF SUMMARY

Aspects of the present disclosure address one or more of the issues mentioned above by disclosing methods, systems and computer readable media for assessing the business value of an account and/or customer. The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

In one embodiment, a method is disclosed comprising the steps of generating an estimated charge off loss amount; calculating a net income value for the account; reducing the net income value for the account by the estimated charge off loss amount; and outputting an adjusted net income value for the account. The adjusted net income for an account and the total adjusted net income for a customer with multiple accounts may be used, in one embodiment, to assess the profitability of the account and/or customer.

In a further embodiment, in accordance with aspects of the disclosure, aspects of the invention may be provided in a computer-readable medium. For example, a computer-readable medium may comprise computer-executable instructions to perform one or more of the method steps described herein.

### BRIEF DESCRIPTION OF THE DRAWINGS

The present disclosure is illustrated by way of example and not limited in the accompanying figures in which like reference numerals indicate similar elements and in which:

FIG. 1 shows an illustrative operating environment in which various aspects of the disclosure may be implemented; and

FIG. 2 illustrates a method for assessing the adjusted net income of an account in which various aspects of the disclosure may be implemented.

### DETAILED DESCRIPTION

In accordance with various aspects of the disclosure, a method and system for enhanced assessment of the business value of an account and/or customer is disclosed. An adjusted net income value (“ANI value”) outputted by a system performing novel aspects of the disclosure may permit a financial institution (e.g., a bank, mortgage broker, lender, credit card company, etc.) or any entity issuing credit to another (e.g., a retailer selling products on an installment payment plan, a dealer selling a vehicle on a loan, a bartender running a tab for a customer, etc.) to better assess the business value of an account; thus, the financial institution may identify those accounts and/or customers that offer greater profitability (i.e., optimize net revenue). For example, in one example, the financial institution may rank (or group) the accounts/customers according to ANI values.

The ANI value for an account that does not charge off and is not delinquent at the end of an observation period is equal to the calculated net income value for the account. For accounts that incur a charge off loss during an observation period, the ANI value is equal to the net income minus the charge off loss amount. For accounts that are delinquent at the end of an observation period, the ANI value is equal to the net income minus the percentage of the past due balance that is predicted to get charged off. The percentage of the past due balance that is predicted to get charged off relates to the number of days the account has been delinquent. For example, a smaller percent of accounts that are only a few days delinquent will charge off, but a more substantial percent of accounts that are a three or four months delinquent will charge off. These and other aspects of the disclosure are discussed in greater detail throughout this disclosure, including the accompanying drawings.

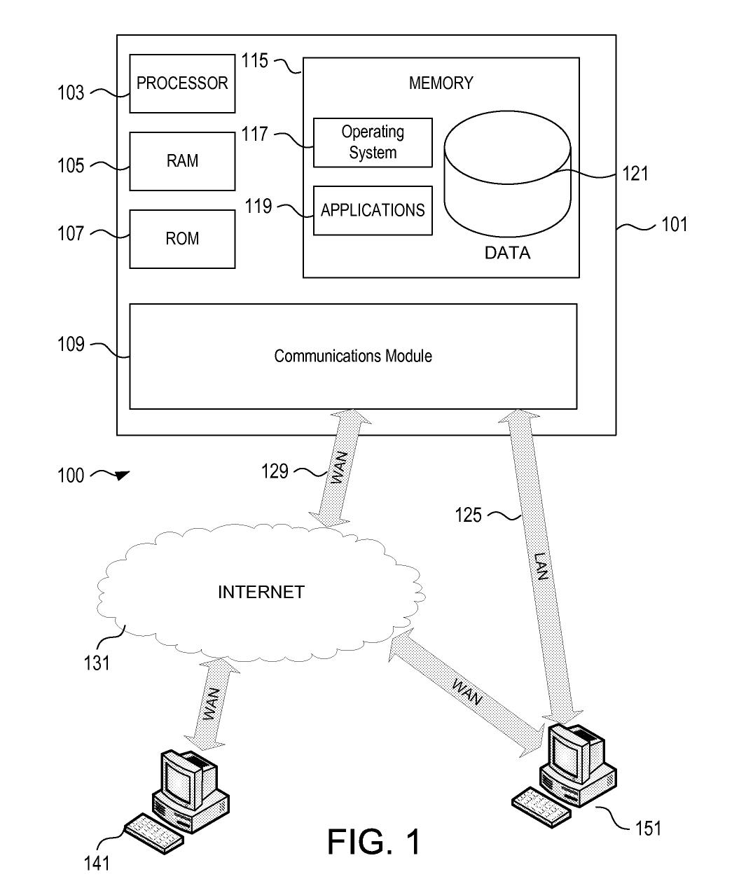

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of components illustrated in the exemplary computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computing device 101 having a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101. Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). As described in detail below, the database 121 may provide centralized storage of account information and account holder information for the entire business, allowing interoperability between different elements of the business residing at different physical locations.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. The network connections depicted in FIG. 1 include a local area network (LAN) 125 and a wide area network (WAN) 129, but may also include other networks. When used in a LAN networking environment, computing device 101 is connected to the LAN 125 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computing device 101 according to an illustrative embodiment of the invention may include computer executable instructions for invoking user functionality related to communication, such as email, short message service (SMS), and voice input and speech recognition applications.

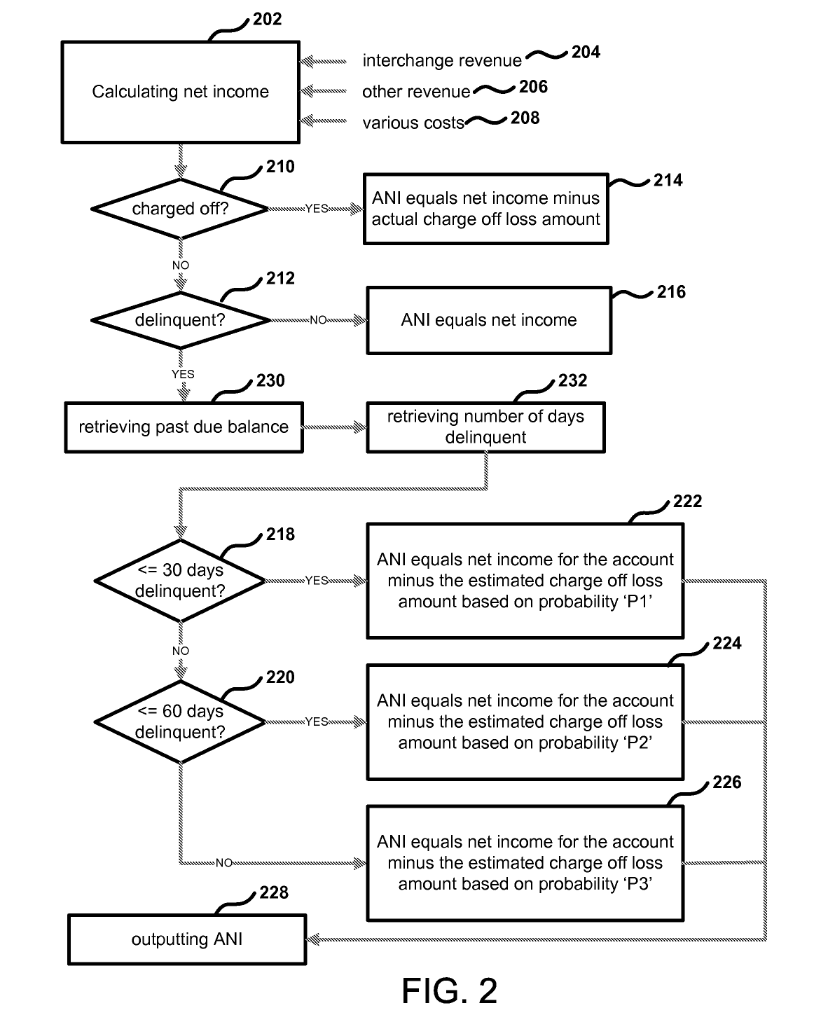

FIG. 2 shows a flow chart illustrating a method for calculating an adjusted net income (“ANI”) value to assess the business value of an account. In step 202, a computing device 101 may calculate a net income value using various input values. The input values may be retrieved from various systems including, but not limited to, a financial accounting system, a customer call center, a remote transactional database, and/or other repository of revenue/cost data. For example, interchange revenue 204, other revenue 206 (e.g., fee revenue, annual fees, late penalty charges, transaction fees, etc.), and/or various costs 208 (e.g., predetermined cost associated with each customer service support communication, monthly paper statement delivery, etc.) may be retrieved and used in calculating net income of an account.

The calculation of net income (step 202) may be used to, among other things, effectively quantify the cost associated with behavior by an accountholder and/or customer related to an account. For example, assuming customer John Doe made a hundred telephone calls to customer service in the past month, the various cost 208 input into the net income calculation may reflect accordingly. In one example, a predetermined cost associated with responding to a customer service telephone call may be accumulated for each of John Doe's hundred telephone calls and deducted from in net income calculation. Meanwhile in another example, a different predetermined cost may be associated with responding to a customer's e-mail to customer service support. In yet another example, customer John Doe may opt to receive monthly paper statements/invoices instead of cheaper electronic statements/invoices, and the net income calculation for his account may be adjusted accordingly in step 202. One of ordinary skill in the art will appreciate that the inputs into calculating net income (in step 202) listed above are a non-exhaustive list and that there exists numerous other examples of activities related to an account that incur costs.

Therefore, in one example a financial institution may make a preliminary assessment that a customer Jane Doe has a greater business value (e.g., profit generation) to the institution than another customer John Doe by examining the net income value. For example, assume Jane Doe and John Doe each carry the same large balance on their accounts (e.g., credit card account) each month. Jane Doe, however, never calls the institution's customer service center. Meanwhile, John Doe calls the customer service center incessantly and frequently visits the institution's branch office location. Accordingly, the calculated net income for John would be less than that of Jane. Such activity-based costing allows the financial institution to allocate costs across accounts where the cost has been incurred.

In another example involving credit card accounts, a financial institution may monitor the interchange revenue generated by an account. For example, customer John Doe pays his credit card bill punctually each month and does not pay any annual fees or transaction charges for his credit card account. Nevertheless, an institution (e.g., credit card company) may calculate a large net income for the account due to the interchange revenue. Therefore, even though the institution is not collecting fees and other revenue from John Doe, the institution may be receiving substantial revenue in the form of interchange fees. In such a context, interchange fees may include a fixed percentage (e.g., 1.25 percent, 2 percent, 3.5 percent, etc.) of the total amount charged by John Doe on the credit card. Thus, the entity received the amount charged by John Doe will receive an amount less than the actual amount charged by John Doe. Meanwhile, the credit card company may collect at least a portion of the interchange revenue. The collected portion may be used in step 202 to calculate net income in accordance with various aspects of the disclosure.

Although the net income value of an account provides a preliminary assessment of an account's business value, an institution may obtain an even more complete assessment of business value once an ANI value has been calculated an account. The ANI is calculated by adjusting the net income value for the account by the estimated charge off loss amount. In those situations (step 210) where an actual charge off has occurred on an account, the estimated charge off loss amount is equal to the actual charge off loss amount. Thus, in step 214, the ANI equals the net income of the account less the actual charge off loss amount.

A charge off occurs when a financial institution concludes that a debt (or a portion of the debt) owed on an account will not be repaid. In some situations the institution may simply remove the past due amount from its books and claim the removed amount as an actual charge off loss amount. Alternatively, the institution may sell the past due amount to another institution for a portion of the past due amount. For example, institution ABC may sell to institution XYZ the rights to collect upon a one thousand dollar past due amount on John Doe's account. Institution XYZ may pay institution ABC only sixty cents on the dollar for such transfer of rights. Therefore, institution ABC may (in step 210) determine that an actual charge off of four hundred dollars has occurred and use this value in determining the ANI for John Doe's account in step 214.

Furthermore, in some industries, rules, regulations, and/or legislation may require an institution to charge off an amount after an account is past due (e.g., delinquent) for more than a predetermined number (e.g., 180) of days. In such examples, the institution may be required to post the charge off to its general ledger as a loss. Thus, a charge off may appear as entire loss on the books. In reality, the institution may be able to later recover at least a portion of the loss at a later date (e.g., using collection agencies, etc.) Therefore, in some examples in accordance with aspects of the disclosure, step 214 may further include adjustments to the ANI to reflect the true business value of the account.

Meanwhile, if the account is not delinquent (see step 212) and has not been charged off, then the net income calculation does not need to be adjusted for an actual and/or estimated charge off loss amount. Thus, in those cases, the ANI equals the net income (in step 216). However, if an account is delinquent (see step 212), but has not completely charged off, then the number of days the account has been delinquent and the past due balance are retrieved in step 230 and 232. The values may be retrieved from memory of a computing device 101, or they may be retrieved from a memory of a remote database storing such information. For example, an electronic accounting system may contain the desired information and be readily accessible for information retrieval. One skilled in the art will appreciate that various different systems may interact and communicate in the retrieval of information and calculation of values in accordance with aspects of the disclosure.

In step 222, step 224, and step 226, an estimated charge off loss amount is generated based on the number of days an account is delinquent (see step 218 and step 220) and the amount the account is past due. In one example, the estimated charge loss amount is generated by multiplying the past due balance with a probability that the past due balance does not get paid based on the number of days of delinquency. As such, the estimated charge loss amount enhances the accuracy of the net income calculation by adjusting that value to account for delinquent past due balances that have not yet been charged off. Step 222, step 224, and step 226 may use statistical models, predictive models, and other methodologies well known to those of ordinary skill in the art to optimize the ANI, including generating a probability value (e.g., 10%, 25%, 2.1%, etc.) based on at least the number of days of delinquency.

In one example, such a probability may be generated using statistical analysis of at least historical data. The historical data may include, but is not limited to, at least a percentage of 30 day delinquent accounts that become 60 days delinquent, percentage of 60 day delinquent accounts that become 90 days delinquent, percentage of 90 day delinquent accounts that become 120 days delinquent, percentage of 120 days delinquent accounts that become 150 days delinquent, percentage of 150 days delinquent accounts that become 180 days delinquent, and percentage of 180 days delinquent accounts that charge off. For example, if the account is less than or equal to 30 days delinquent (see step 218), then the estimated charge off loss amount equals the balance on the account times the percent of 30 day delinquent accounts that become 60 days delinquent times the percent of 60 day delinquent accounts that become 90 days delinquent times the percent of 90 day delinquent accounts that become 120 days delinquent times the percent of 120 day delinquent accounts that become 150 days delinquent times the percent of 150 day delinquent accounts that become 180 days delinquent times the percent of 180 day delinquent accounts that charge off. One skilled in the art will recognize that

In addition, an account may be grouped according to the number of days of delinquency. For example, an account that is between 5 days delinquent to 30 days delinquent may be assigned to the “bucket one” group in the collections group. Once the delinquency goes past 30 days, then the account is in the 30-60 day bucket, which is sometimes referred to as “bucket two.” Accordingly the probabilities (i.e., P1, P2, P3) used in steps 222, 224, and 226 may depend on the collections groups to which they belong. For example, the “bucket one” group may contains various accounts that are delinquent for different reasons. It may contain accounts that have simply forgotten to pay. It may also contain accounts of customers that were on vacation and put their checks in the mailbox from a distant location and the mail was not timely delivered. It may also contain those accounts of customers that are simply never going to pay; the past due balances on these accounts will eventually roll into the “bucket two” group.

Using various techniques known to those of skill in the art, probabilities (for use in steps 222, 224, 226) may be generated relating to how many percent of those in the “bucket one” group will make it into the “bucket two” group and how many will eventually be charged off. Thus, the probabilities associated with each bucket group may vary accordingly. For example, the percentages may get higher as the delinquency progresses. A customer that has simply forgotten to pay (i.e., has an account in the “bucket one” group) will most likely have received phone call reminders, mail, etc. and will pay the past due balance within a reasonable time. Therefore, as the delinquency progresses, it appears more likely that the account will charge off, and it was not simply a case of forgetting to pay a bill.

Aspects of the disclosure may be applied to a plethora of different account types, for example, mortgage accounts, credit card accounts, line of credit, etc. While aspects of the disclosure may be applied to the banking industry, one skilled in the art will appreciate that other industries and fields may also benefit. For example, aspects of the disclosure may be applied to the retail industry where a customer with an account at a retail outlet can purchase items on the retail outlet's credit. The customer then receives a monthly bill for the items purchased. In another example, an account at a supplier (e.g., of construction parts) may use aspects of the disclosure to issue credit and assess the business value of its customers and/or accounts.

In another example in accordance with various aspects of the disclosure, a single entity may be associated with a plurality of accounts from a financial institution. The single entity may be a company (or group of companies/subsidiaries) or an individual. The financial institution may assess the business value of the single entity by summing (i.e., adding together) the ADI value of each of the plurality of accounts associated with the single entity to generate a total ADI value for the single entity. The total ADI value may allow the institution to assess whether the customer, with it's numerous accounts, is overall profitable to the institution. The institution may use the total ADI value for the single entity to determine if it wishes to reject activity of the single entity. For example, the institution may find that total ANI value of the customer is below a predetermined threshold value (e.g., below a profitability level) and choose to block the customer from activities that would further lower the total ANI value of the customer. The institution may wish to allow, however, customer activities, such as paying past due amounts, that would raise the total ANI value of the customer. Other examples of customer activities include, but are not limited to, withdrawing additional credit, making additional purchases, and others.

One of ordinary skill in the art will appreciate that although aspects of the disclosure have been described in terms of net income and adjusted net income, the two values need not necessarily be separated as indicated. For example, the adjusted net income may be incorporated into the net income calculation in step 202. In such an embodiment, the past due balance, number of days delinquent, and other information may be provided along with the revenue and cost information. In addition, aspects of the disclosure may encompass the calculation of other values related to the adjusted net income, such as adjusted gross revenue and/or gross revenue. Such calculations will be apparent to one of skill in the art after review of the entirety disclosed herein.

Another embodiment of the disclosure includes forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, one of ordinary skill in the art will appreciate that various aspects described herein may be embodied as a method, a data processing system, or as a computer-readable medium storing computer-executable instructions. For example, a computer-readable medium storing instructions to cause a processor to perform steps of a method in accordance with aspects of the disclosure is contemplated. For example, aspects of the method steps disclosed herein may be executed on a processor on a computing device 101. Such a processor may execute computer-executable instructions stored on a computer-readable medium.

Aspects of the invention have been described in terms of illustrative embodiments thereof Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

We claim:

1. A computer-assisted method comprising:
generating an estimated charge off loss amount based on a number of days an account is delinquent;
adjusting a net income value for the account by the estimated charge off loss amount; and
outputting an adjusted net income value.

2. The method of claim 1, where the generating the estimated charge off loss amount includes:
retrieving from memory a past due balance on the account;
retrieving from memory a number of days the account is delinquent; and
multiplying the past due balance with a probability that the past due balance does not get paid based on the number of days of delinquency, where the probability is generated using statistical analysis of at least historical data.

3. The method of claim 2, where the historical data includes at least one of: percentage of 30 day delinquent accounts that become 60 days delinquent, percentage of 60 day delinquent accounts that become 90 days delinquent, percentage of 90 day delinquent accounts that become 120 days delinquent, percentage of 120 days delinquent accounts that become 150 days delinquent, percentage of 150 days delinquent accounts that become 180 days delinquent, and percentage of 180 days delinquent accounts that charge off.

4. The method of claim 1, further comprising:
calculating the net income value for the account.

5. The method of claim 4, where the net income value is calculated using interchange revenue.

6. The method of claim 5, where the net income value is calculated using fee revenue.

7. The method of claim 6, where the net income value is calculated using predetermined costs associated with customer service communication.

8. The method of claim 1, where the estimated charge off loss amount is an actual charge off loss amount for the account if the account has been charged off.

9. The method of claim 1, where the account is a mortgage account.

10. The method of claim 1, where the account is a credit card account.

11. The method of claim 1, where the account is a line of credit.

12. The method of claim 1, where a single entity is associated with a plurality of accounts, the method further comprising:
summing the adjusted net income value of each of the plurality of accounts associated with the single entity to generate a total adjusted net income value of the single entity; and
rejecting activity of the single entity based on its effect on the total adjusted net income value.

13. The method of claim 2, further comprising:
if the adjusted net income value of the account is below a predetermined threshold value, then rejecting customer activity on the account that causes an increase in the past due balance on the account.

14. A tangible computer-readable medium storing computer-executable instructions that cause a processor to perform a method comprising:
receiving a past due balance on an account;
receiving a number of days the account is delinquent;
multiplying the past due balance with a probability that the past due balance does not get paid based on the number of days of delinquency to generate an estimated charge off loss amount;
adjusting a net income value for the account by the estimated charge off loss amount to generate an adjusted net income value; and
outputting the adjusted net income value.

15. The computer-readable medium of claim 14, where the account is one of: a mortgage account, a credit card account, and a line of credit.

16. The computer-readable medium of claim 14, where a single entity is associated with a plurality of accounts, the method further comprising:
summing the adjusted net income value of each of the plurality of accounts associated with the single entity to generate a total adjusted net income value of the single entity; and
outputting an indication to reject activity of the single entity based on its effect on the total adjusted net income value.

17. The computer-readable medium of claim 14, further comprising:
if the adjusted net income value of the account is below a predetermined threshold value, then rejecting customer activity on the account that causes an increase in the past due balance on the account.

18. A method comprising:
generating an estimated charge off loss amount by multiplying a past due balance on an account with a probability that the past due balance does not get paid based on a number of days the account is delinquent;
calculating a net income value for the account using at least one of: interchange revenue, fee revenue, and predetermined costs associated with customer service communication;
reducing the net income value for the account by the estimated charge off loss amount; and
outputting an adjusted net income value for the account.

19. The method of claim 18, where the probability is generated using statistical analysis of at least historical data, where the historical data includes a percentage of 30 day delinquent accounts that become 60 days delinquent and a percentage of 60 day delinquent accounts that become 90 days delinquent.

20. The method of claim 18, where if the adjusted net income value of the account is below a predetermined threshold value, then rejecting customer activity on the account that causes an increase in the past due balance on the account.
